(19) United States
(12) Patent Application Publication
(10) Pub. No.: US 2017/0029297 A1
(43) Pub. Date: Feb. 2, 2017

(54) ELECTROLYTIC APPARATUS AND METHOD FOR PRODUCING ELECTROLYZED WATER

(71) Applicant: KABUSHIKI KAISHA TOSHIBA, Tokyo (JP)

(72) Inventors: Masahiro YOKOTA, Fukaya Saitama (JP); Hideo OOTA, Tokyo (JP); Hisashi CHIGUSA, Yokohama Kanagawa (JP); Hidemi MATSUDA, Toda Saitama (JP)

(73) Assignee: KABUSHIKI KAISHA TOSHIBA, Tokyo (JP)

(21) Appl. No.: 15/266,399

(22) Filed: Sep. 15, 2016

Related U.S. Application Data
(63) Continuation of application No. PCT/JP2015/054980, filed on Feb. 23, 2015.

(30) Foreign Application Priority Data
Sep. 22, 2014 (JP) 2014-192955

(51) Int. Cl. C02F 1/461

(52) U.S. Cl. CPC C02F 1/4618; C02F 1/46104; C02F 2201/46115; C02F 2201/46145

(57) ABSTRACT

According to one embodiment, an electrolytic apparatus includes an electrolytic cell including a cathode chamber, an intermediate chamber, and an anode chamber, a supply portion which supplies an electrolyte solution to the intermediate chamber, a drain pipe which discharges the electrolyte solution from the intermediate chamber, and a valve in the drain pipe. The supply portion includes a pressure apply portion which applies hydrostatic pressure to the electrolyte solution in the intermediate chamber made static, and which includes a supply pipe, a pump in the supply pipe, and a circulation pipe configured to circulate a part of the electrolyte solution fed from the pump.

### CROSS REFERENCE TO RELATED APPLICATIONS

This application is a Continuation Application of PCT Application No. PCT/JP2015/054980, filed Feb. 23, 2015 and based upon and claiming the benefit of priority from Japanese Patent Application No. 2014-192955, filed Sep. 22, 2014, the entire contents of all of which are incorporated herein by reference.

### FIELD

Embodiments described herein relate generally to an electrolytic apparatus.

### BACKGROUND

Conventionally, electrolytic apparatuses comprising a three-compartment electrolytic cell have been used as a device for producing alkali ion water, ozone water, hypochlorous acid water or the like. The three-compartment electrolytic cell comprises a casing divided into an anode chamber, an intermediate chamber and a cathode chamber by a cation exchange membrane and an anion exchange membrane. The anode chamber and the cathode chamber are provided respectively with an anode and a cathode. For example, hypochlorous acid water is produced by the following processes by the electrolytic apparatus. A salt solution is supplied to the intermediate chamber as an electrolyte solution, and water is supplied to the anode chamber and the cathode chamber. Then, the salt solution in the intermediate chamber is electrolyzed at the anode and at the cathode, and gaseous chlorine is produced in the anode chamber. The gaseous chlorine reacts with water in the anode chamber, and consequently hypochlorous acid water is produced. Simultaneously, gaseous hydrogen is produced in the cathode chamber, and sodium hydroxide water is produced.

In this electrolytic apparatus, the cation exchange membrane and the anion exchange membrane have ion diffuseness different from each other, and further substances might enter the intermediate chamber from the anode chamber and the cathode chamber through the ion-exchange membranes. Therefore, if the electrolyte solution is circulated and supplied to the intermediate chamber, the properties, in particular, the pH level of an electrolyte solution in the intermediate chamber changes. On the other hand, if an electrolyzed electrolyte solution is discharged without being circulated so as to supply an electrolyte solution having a stable pH level, the consumption of the electrolyte solution increases. Further, in order to reduce the consumption of an electrolyte solution, a technique of supplying an electrolyte solution intermittently to the intermediate chamber so as to replace the electrolyte solution as consumed has been proposed. In this case, hydraulic pressure is applied to the electrolyte solution in the intermediate chamber by providing a tank storing an electrolyte solution in a position higher than the electrolytic cell to use hydraulic head pressure.

However, in the case of supplying an electrolyte solution intermittently, there is a problem that an appropriate hydraulic pressure cannot be applied to the intermediate chamber when the supplying of the electrolyte solution to the intermediate chamber is stopped. Further, if the tank storing an electrolyte solution is located higher than the electrolytic cell as described above, there is a problem that the overall size of the electrolytic apparatus increases.

### BRIEF DESCRIPTION OF THE DRAWINGS

FIG. 1 is a schematic diagram showing the structure of an electrolytic apparatus of a first embodiment.

FIG. 2 is a schematic diagram showing the structure of an electrolytic apparatus of a second embodiment.

FIG. 3 is a schematic diagram showing the structure of an electrolytic apparatus of a third embodiment.

FIG. 4 is a schematic diagram showing the structure of an electrolytic apparatus of a fourth embodiment.

### DETAILED DESCRIPTION

Various embodiments will be described hereinafter with reference to the accompanying drawings. In general, according to one embodiment, an electrolytic apparatus comprises: an electrolytic cell comprising a first separating membrane configured to separate an intermediate chamber to which an electrolyte solution is supplied and an anode chamber, a second separating membrane configured to separate the intermediate chamber and a cathode chamber, an anode provided in the anode chamber to face the first separating membrane, and a cathode provided in the cathode chamber to face the second separating membrane; a supply portion configured to supply the electrolyte solution to the intermediate chamber; a drain pipe comprising an end opened to an outside and configured to discharge the electrolyte solution from the intermediate chamber; and a valve provided in the drain pipe and configured to make the electrolyte solution in the intermediate chamber static. The supply portion comprises a pressure apply portion configured to apply hydrostatic pressure to the electrolyte solution in the intermediate chamber made static, a supply pipe connected to the intermediate chamber, a pump provided in the supply pipe to feed an electrolyte solution to the intermediate chamber, and a circulation pipe configured to circulate a part of the electrolyte solution fed from the pump.

Note that the components of each embodiment, which are identical to those of any other embodiment, are designated by the same reference numbers and symbols and are not described repeatedly. Further, each drawing is a schematic diagram showing an embodiment and promoting an understanding thereof. The shape, dimension, ratio and the like shown in the drawings may be different from those of a device actually implemented and may be appropriately changed on the basis of the following descriptions and prior arts. Note that the static water in the embodiments does not necessarily mean a completely static fluid. The static water may mean a fluid so tranquil that ions pass unintentionally through a porous membrane not having ion selectivity in a predetermined time is significantly few or a fluid having a significantly small pressure. Further, in the embodiments, an electrolyzed solution is assumed to be water such as acid water or alkali water produced through electrolysis.

### First Embodiment

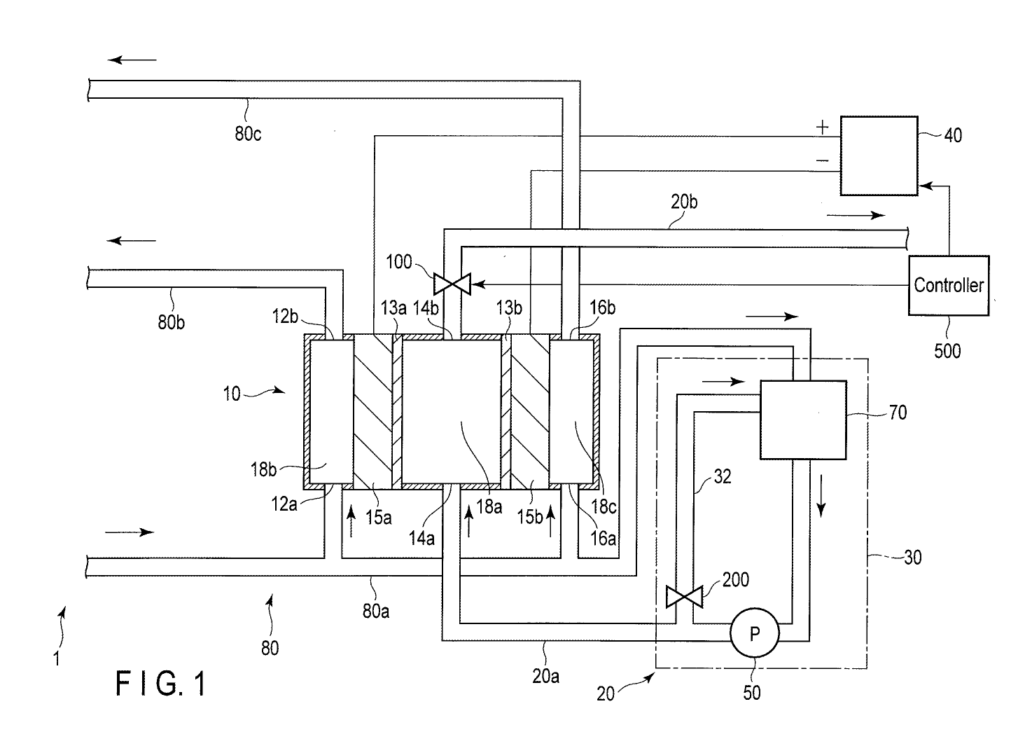

FIG. 1 is a schematic diagram showing the overall structure of an electrolytic apparatus 1 of the first embodiment. As shown in FIG. 1, the electrolytic apparatus 1 comprises a three-compartment electrolytic cell 10. The electrolytic cell 10 comprises, for example, a substantially rectangular box-shaped casing, and the casing is divided into an intermediate chamber 18a, and an anode chamber 18b and a cathode chamber 18c located on both sides of the intermediate chamber 18a by a first separating membrane, for example, an anion exchange membrane 13a and a second separating membrane, for example, a cation exchange membrane 13b. The anode chamber 18b comprises an anode 15a provided in proximity to the anion exchange membrane 13a, and the cathode chamber 18c comprises a cathode 15b provided in proximity to the cation exchange membrane 13b. The cation exchange membrane 13b allows positive ions passing through and does not allow negative ions passing through. Further, the anion exchange membrane 13a allows negative ions passing through and does not allow positive ions passing through. The cation exchange membrane 13b and the anion exchange membrane 13a may be made of known materials. A non-woven material may be interposed between the anode 15a and the anion exchange membrane 13a. Similarly, a non-woven material may be interposed between the cathode 15b and the cation exchange membrane 13b.

In the above-described electrolytic cell 10, the intermediate chamber 18a comprises a first inflow port 14a into which an electrolyte solution flows, and a first outflow port 14b from which the electrolyte solution having flowed in the intermediate chamber is discharged. The anode chamber 18b comprises a second inflow port 12a into which source water to be electrolyzed flows, and a second outflow port 12b from which the source water having flowed in the anode chamber 18b is discharged. The cathode chamber 18c comprises a third inflow port 16a into which source water to be electrolyzed flows, and a third outflow port 16b from which the source water having flowed in the cathode chamber 18c is discharged.

The electrolytic apparatus 1 further comprises, in addition to the electrolytic cell 10, an electrolyte solution supply portion 20 configured to supply an electrolyte solution, for example, a saturated salt solution to the intermediate chamber 18a of the electrolytic cell 10, a source water supply portion 80 configured to supply source water to be electrolyzed, for example, water to the anode chamber 18b and the cathode chamber 18c, a power 40 configured to apply positive voltage and negative voltage respectively to the anode 15a and the cathode 15b, and a controller 500 configured to control the operations of the electrolyte solution supply portion 20 and the power 40.

The source water supply portion 80 comprises a water supply source (not shown) configured to supply water, a water supply pipe 80a configured to guide water to the lower portions of the anode chamber 18b and the cathode chamber 18c from the water supply source and to supply water to a salt solution tank 70, a first drain pipe 80b configured to discharge water having flowed in the anode chamber 18b from the upper portion of the anode chamber 18b, and a second drain pipe 80c configured to discharge water having flowed in the cathode chamber 18c from the upper portion of the cathode chamber 18c.

Note that the water supply pipe 80a splits into three, and that one end is connected to the second inflow port 12a provided in the anode chamber 18b, another end is connected to the third inflow port 16a provided in the cathode chamber 18c and the other end is connected to an inflow port provided in the salt solution tank 70. The water supply pipe 80a connected to the salt solution tank 70 supplies water to the salt solution tank 70 at appropriate times by controlling an electromagnetic valve (not shown) so that the salt solution tank 70 will not run dry. Further, one end of the first drain pipe 80b is connected to the second outflow port 12b provided in the anode chamber 18b, and one end of the second drain pipe 80c is connected to the third outflow port 16b provided in the cathode chamber 18c.

The second inflow port 12a and the third inflow port 16a on their upper streams are provided with flow controllers (not shown) configured to control the volume of water flowing in the anode chamber 18b and the cathode chamber 18c to be 2 L/min. Note that flow channels and pipes are designed in such a manner that the hydraulic pressure in the anode chamber 18b and the cathode chamber 18c becomes 6 kPa when a reference flow rate is 2 L/min.

The electrolyte solution supply portion 20 comprises the salt solution tank 70 configured to produce and store a saturated salt solution, a supply pipe 20a configured to guide the saturated salt solution from the salt solution tank 70 to the intermediate chamber 18a, a solution feed pump 50 provided in the supply pipe 20a, a circulation pipe 32 provided between the solution feed pump 50 and the intermediate chamber 18a, diverged from the supply pipe 20a, and connected to the salt solution tank 70, a flow control valve 200 provided in the circulation pipe 32 and operated manually, a drain pipe 20b configured to discharge an electrolyte solution having flowed in the intermediate chamber 18a, and an electromagnetic valve 100 provided in the drain pipe 20b. One end of the supply pipe 20a is connected to the first inflow port 14a provided in the intermediate chamber 18a, and one end of the drain pipe 20b is connected to the first outflow port 14b provided in the intermediate chamber 18a. In the present embodiment, the other end of the drain pipe 20b opens to the outside. The electromagnetic valve 100 is controlled by the controller 500 to open and close.

In the electrolyte solution supply portion 20, the salt solution tank 70, the solution feed pump 50, the circulation pipe 32, the flow control valve 200 and a part of the supply pipe 20a constitute a hydraulic pressure apply portion 30 configured to apply a predetermined hydraulic pressure (enclosed by a broken line in FIG. 1). The salt solution tank 70 may be omitted from the hydraulic pressure apply portion 30 and may be provided separate from the portion 30.

In the electrolytic apparatus 1 having the above-described structure, the solution feed pump 50 is operated to circulate an electrolyte solution in the hydraulic pressure apply portion 30 through the circulation pipe 32, the electromagnetic valve 100 of the drain pipe 20b is closed to make an electrolyte solution in the intermediate chamber 18a static, and the flow control valve 200 of the circulation pipe 32 is appropriately closed to apply a hydraulic pressure of 10 kPa, which is greater than the hydraulic pressure in the anode chamber 18b and the cathode chamber 18c, to the intermediate chamber 18a connected to the circulation pipe 32 while keeping the electrolyte solution static.

The hydraulic pressure applied to the intermediate chamber 18a is controllable by controlling the throttle of the flow control valve 200. It is possible in the electrolytic apparatus 1 of the embodiment to control the hydraulic pressure in the intermediate chamber 18a, for example, in the range of 0 to 20 kPa. Since the characteristics of electrolysis become more stable with the structure that the anion exchange membrane 13a and the cation exchange membrane 13b are attached tightly to the anode 15a and the cathode 15b by hydraulic pressure, it is preferable that the hydraulic pressure of the intermediate chamber 18a be greater than those of the anode chamber 18b and the cathode chamber 18c. Since water is running in the anode chamber 18b and the cathode chamber 18c, it is difficult to make the hydraulic pressures zero. However, in the present embodiment, even if the electromagnetic valve 100 of the drain pipe 20b is closed and an electrolyte solution of the intermediate chamber 18a is made static, a hydraulic pressure can be appropriately applied to the intermediate chamber 18a by operating the solution feed pump 50 to circulate an electrolyte solution through the circulation pipe 32 and controlling the pressure of the flowing solution with the flow control valve 200 at appropriate times.

In the electrolytic apparatus 1 of the first embodiment, the electromagnetic valve 100 is opened to discharge and dispose of a fully electrolyzed electrolyte solution in the intermediate chamber 18a. By discharging the electrolyte solution electrolyzed in the electrolytic cell 10 at appropriate times, the electrolyte solution in the intermediate chamber 18a is replaced with a fresh electrolyte solution. Therefore, the electrolytic apparatus 1 of the embodiment is not influenced by change in the properties of an electrolyte solution. The time interval to open and close the electromagnetic valve 100 is controllable and may be set appropriately by estimating the amount of the electrolyte consumed in electrolysis, and the period of opening the valve is controllable based on the volume of the intermediate chamber 18a. Further, it is also possible to set a time to open and close the electromagnetic valve 100 by further providing the controller 500. For example, it is possible to open and close the electromagnetic valve 100 to replace the electrolyte solution when the electrolyte solution has been consumed and the electrolytic voltage is greater than a certain value.

The operation of the electrolytic apparatus 1 of the above-described structure to electrolyze a salt solution to produce acid water (hypochlorous acid and hydrochloric acid) and alkali water (sodium hydrate) will be described below.

First, in a state in which the electromagnetic valve 100 is closed, the solution feed pump 50 is operated to apply an appropriate hydraulic pressure to the intermediate chamber 18a of the electrolytic cell 10 and to supply water to the anode chamber 18b and the cathode chamber 18c. With the electromagnetic valve 100 closed, when the intermediate chamber 18a is filled up with a saturated salt solution, a part of the saturated salt solution flows back to the salt solution tank 70 through the circulation pipe 32. By appropriately throttling the flow control valve 200 and controlling the saturated salt solution circulating through the circulation pipe 32, it is possible to apply an appropriate hydraulic pressure to the intermediate chamber 18a connected to the circulation pipe 32. In the present embodiment, a setting is made to control the flow control valve 200 to apply a hydraulic pressure of 10 kPa to the intermediate chamber 18a and to supply water to the anode chamber 18b and the cathode chamber 18c at a rate of 2 L/min to apply a hydraulic pressure of 4 to 6 kPa.

Subsequently, positive voltage and negative voltage are applied respectively to the anode 15a and the cathode 15b from the power 40. The voltage application to the anode 15a and the cathode 15b is controlled by the controller 500. Here, if a change in hydraulic pressure should be avoided while replacing an electrolyte solution of the intermediate chamber 18a, the voltage application may be started when the electromagnetic valve 100 is closed and the voltage application may be stopped when the electromagnetic valve 100 is opened.

Sodium ions ionized in the salt solution flowed into the intermediate chamber 18a are attracted to the cathode 15b, pass through the cation exchange membrane 13b, and flow into the cathode chamber 18c. In the cathode chamber 18c, water is electrolyzed at the cathode to produce gaseous hydrogen and hydroxyl ion, and then aqueous sodium hydroxide is produced. Aqueous sodium hydroxide and gaseous hydrogen produced in this way flow out from the third outflow port 16b of the cathode chamber 18c to the second drain pipe 80c. The produced aqueous sodium hydroxide (alkali water) is discharged through the second drain pipe 80c.

Further, chlorine ions ionized in the salt solution in the intermediate chamber 18a are attracted to the anode 15a, pass through the anion exchange membrane 13a, and flow into the anode chamber 18b. Gaseous chlorine is then produced at the anode 15a. Subsequently, the gaseous chlorine reacts with water in the anode chamber 18b to produce hypochlorous acid and hydrochloric acid. The acid water (hypochlorous acid and hydrochloric acid) produced in this way is discharged from the second outflow port 12b of the anode chamber 18b through the first drain pipe 80b.

The salt solution of the intermediate chamber 18a is replaced and disposed of when the consumption of the solution has been made and the time is right by opening the electromagnetic valve 100. As to the time and the amount in the replacement, the replacement may be performed on a regular basis or the replacement may be performed by detecting an increase in the electrolytic voltage. Further, it is possible to continue or temporarily stop electrolyzing an electrolyte solution while the replacement is carried out. The salt solution is discharged by opening the electromagnetic valve 100 to supply a new saturated salt solution to the intermediate chamber 18a by the solution feed pump 50 and to expel the old salt solution. A sequence of processing in the electrolytic apparatus 1 of the first embodiment has been described above.

As described above, the hydraulic pressure in the intermediate chamber 18a is higher in comparison to that of the anode chamber 18b and the cathode chamber 18c. Therefore, the cation exchange membrane 13b and the anion exchange membrane 13a are pushed onto the anode 15a and the cathode 15b and attached respectively to the cathode 15b and the anode 15a tightly and evenly. Consequently, it is possible to prevent increase in electrolytic resistance and to perform electrolysis stably. Further, since the cation exchange membrane 13b and the anion exchange membrane 13a as soft membranes are in close proximity to the electrodes, it is possible to prevent increase in diffusion resistance and to maintain a low and stable electrolytic voltage. For this reason, it becomes possible to reduce power necessary to obtain alkali water or acid water of a desired concentration.

In this way, according to the first embodiment, it is possible in the electrolytic apparatus 1 comprising a three-compartment electrolytic cell to make the electrolyte solution static while appropriately applying hydraulic pressure to the intermediate chamber 18a and replace the consumed electrolyte solution at appropriate times when performing electrolysis. Consequently, the electrolytic apparatus 1 can perform electrolysis efficiently at a stable pH level. Further, unlike a type which applies hydraulic pressure by using head hydraulic head pressure, the electrolytic apparatus 1 circulates the electrolyte solution to apply hydraulic pressure to the intermediate chamber 18a, and thus it is possible to prevent an increase in the overall size of the electrolytic apparatus 1.

Next, electrolytic apparatuses of other embodiments will be described. Note that the components of the embodiments, which are identical to those of the first embodiment, are designated by the same reference numbers and symbols and are not described repeatedly, and that the descriptions will be focused more on the components of the embodiments different from those of the first embodiment.

### Second Embodiment

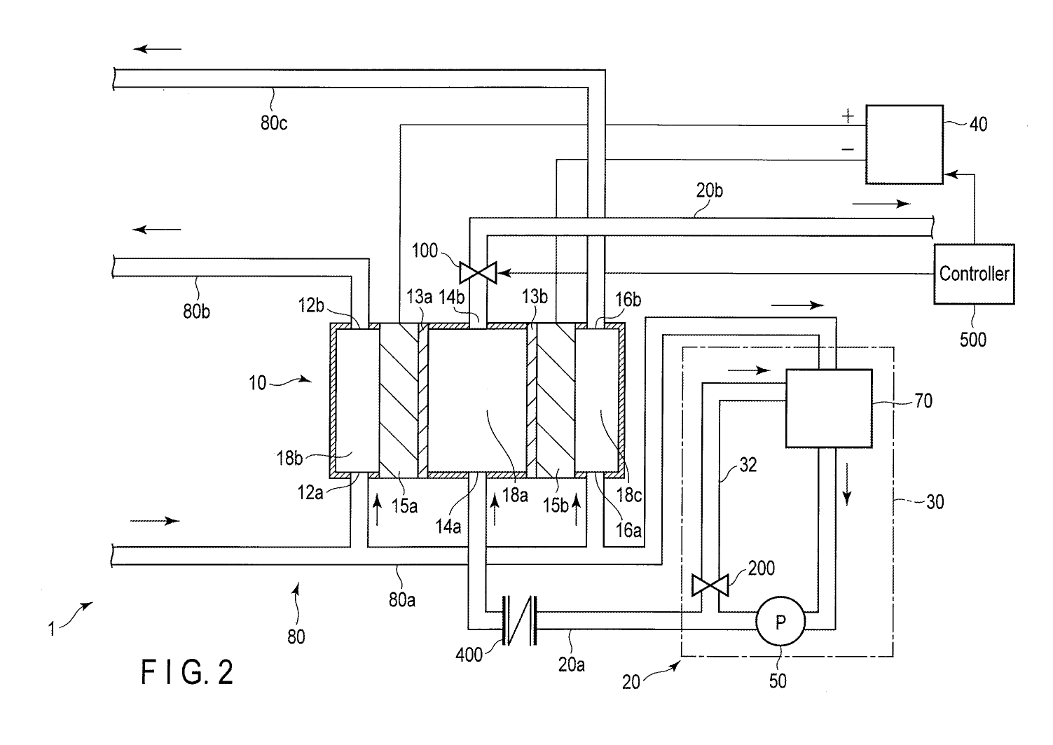

FIG. 2 is a schematic diagram showing the structure of an electrolytic apparatus 1 of the second embodiment. The electrolytic apparatus 1 of the second embodiment further comprises a check valve 400 provided in the supply pipe 20a between the intermediate chamber 18a and the circulation pipe 32. The check valve 400 is configured to allow an electrolyte solution to be supplied to the intermediate chamber 18a through the supply pipe 20a, and to restrain the electrolyte solution of the intermediate chamber 18a from running back toward the pump 50.

In the second embodiment, the rest of the components of the electrolytic apparatus 1 are similar to those of the electrolytic apparatus 1 of the first embodiment.

The electrolytic apparatus 1 of the second embodiment having the above-described structure can prevent an electrolyte solution the properties of which has changed in the intermediate chamber 18a from mixing with an electrolyte solution on the supply pipe 20a side.

According to the second embodiment, in a manner similar to that of the first embodiment, it is possible in performing electrolysis to make an electrolyte solution static while appropriately applying hydraulic pressure to the intermediate chamber 18a, and to replace the consumed electrolyte solution at appropriate times, and therefore efficient electrolysis at a stable pH level can be realized. Further, unlike a type which applies hydraulic pressure by using head hydraulic head pressure, the electrolytic apparatus 1 circulates the electrolyte solution to apply hydraulic pressure to the intermediate chamber 18a, and thus it is possible to prevent an increase in the overall size of the electrolytic apparatus 1.

### Third Embodiment

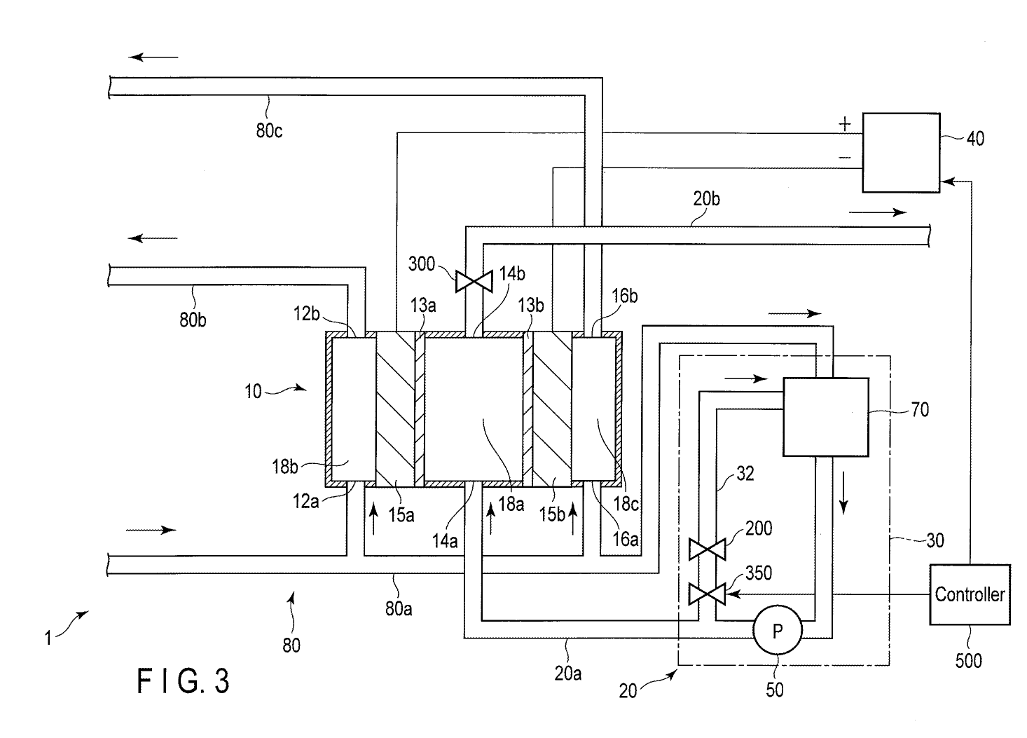

FIG. 3 is a schematic diagram showing the structure of an electrolytic apparatus 1 of the third embodiment. The electrolytic apparatus 1 of the third embodiment comprises a safety valve 300 instead of the electromagnetic valve 100, the safety valve 300 provided in the drain pipe 20b and configured to open by a hydraulic pressure of 15 kPa, and further comprises an electromagnetic valve 350 in the circulation pipe 32 in addition to the manual valve 200. Further, a pump configured to apply a hydraulic pressure of 20 kPa is used as the solution feed pump 50. In the third embodiment, the rest of the components of the electrolytic apparatus 1 are similar to those of the electrolytic apparatus 1 of the first embodiment.

The above-described safety valve 300 opens when the hydraulic pressure of the intermediate chamber 18a becomes 15 kPa or more. In a state in which the electromagnetic valve 350 is open, a salt solution flows through the circulation pipe 32 and is controlled by the manual valve 200 to apply a hydraulic pressure of 10 kPa to the intermediate chamber 18a. That is, when the electromagnetic valve 350 is open in the electrolytic apparatus 1 of the third embodiment, the safety valve 300 remains closed, and the solution of the intermediate chamber 18a is kept static while being subjected to a hydraulic pressure of 10 kPa.

Further, when the electromagnetic valve 350 is closed, a hydraulic pressure of 20 kPa corresponding to the capacity of the solution feed pump 50 is applied to the intermediate chamber 18a, and the safety valve 300 in the drain pipe 20b is pushed open. As a result, a salt solution in the intermediate chamber 18a is discharged and disposed of through the drain pipe 20b. Simultaneously, a new salt solution is supplied to the intermediate chamber 18a. That is, in the electrolytic apparatus 1 of the third embodiment, when the electromagnetic valve 350 is closed, the safety valve 300 remains open and a salt solution is continuously discharged from the intermediate chamber 18a.

As described above, in the third embodiment, a salt solution can be supplied for electrolysis by opening the electromagnetic valve 350 and the salt solution used for electrolysis can be discharged by closing the electromagnetic valve 350.

According to the third embodiment, in a manner similar to that of the first embodiment, it is possible in performing electrolysis to make an electrolyte solution static while appropriately applying hydraulic pressure to the intermediate chamber 18a, and to replace the consumed electrolyte solution at appropriate times, and therefore an efficient electrolysis at a stable pH level can be realized. Further, unlike a type which applies hydraulic pressure by using head hydraulic head pressure, the electrolytic apparatus 1 circulates the electrolyte solution to apply hydraulic pressure to the intermediate chamber 18a, and thus it is possible to prevent an increase in the overall size of the electrolytic apparatus 1.

### Fourth Embodiment

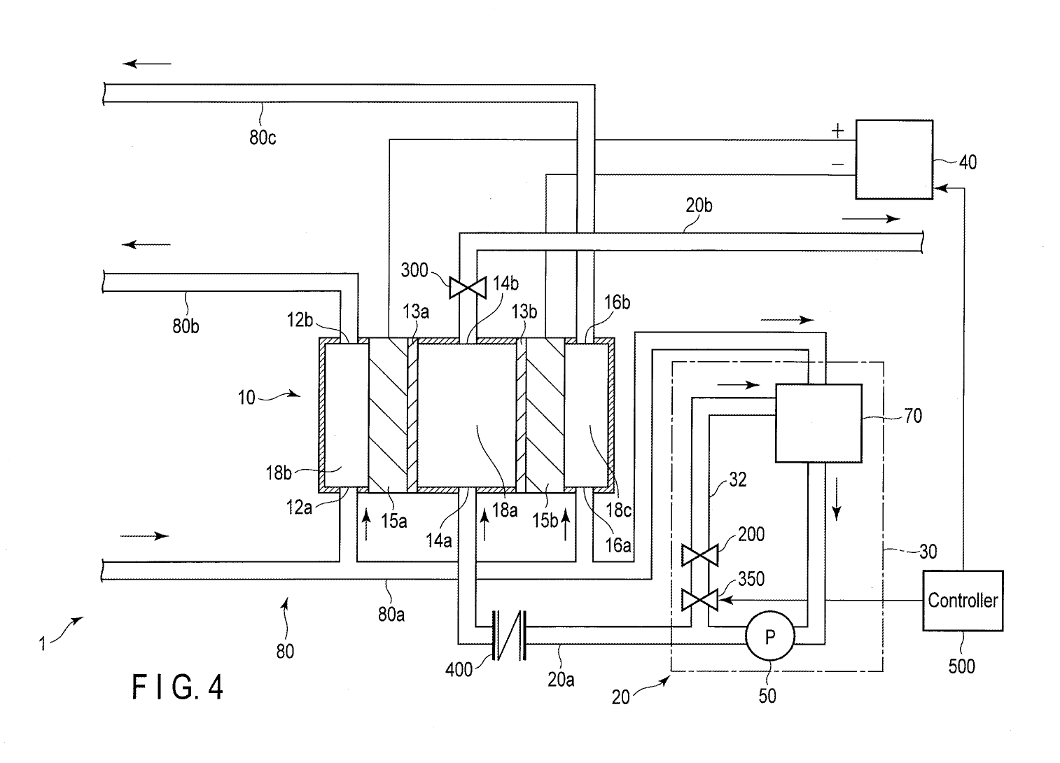

FIG. 4 is a schematic diagram showing the structure of an electrolytic apparatus 1 of the fourth embodiment. The electrolytic apparatus 1 of the fourth embodiment further comprises a check valve 400 provided in the supply pipe 20a between the intermediate chamber 18a and the circulation pipe 32. The check valve 400 is configured to allow an electrolyte solution to be supplied from the supply pipe 20a to the intermediate chamber 18a, and to restrain the electrolyte solution of the intermediate chamber 18a from running back toward the pump 50. In the fourth embodiment, the rest of the components of the electrolytic apparatus 1 are similar to those of the electrolytic apparatus 1 of the third embodiment.

The electrolytic apparatus 1 of the fourth embodiment having the above-described structure can prevent an electrolyte solution the properties of which has changed in the intermediate chamber 18a from mixing with an electrolyte solution on the supply pipe 20a side.

According to the fourth embodiment, in a manner similar to that of the third embodiment, it is possible in performing electrolysis to make an electrolyte solution static while appropriately applying hydraulic pressure to the intermediate chamber 18a, and to replace the consumed electrolyte solution at appropriate times, and therefore an efficient electrolysis at a stable pH level can be realized. Further, unlike a type which applies hydraulic pressure by using head hydraulic head pressure, the electrolytic apparatus 1 circulates the electrolyte solution to apply hydraulic pressure to the intermediate chamber 18a, and thus it is possible to prevent an increase in the overall size of the electrolytic apparatus 1.

The above-described embodiments are in no way restrictive. When implementing them, modifications may be made without departing from the spirit of the embodiments. Further, a plurality of structural elements described in the above-described embodiments may be appropriately combined with each other to constitute various inventions. For example, some of the structural elements disclosed in the embodiments may be deleted. Further, the structural elements described in a plurality of embodiments may be appropriately combined with each other.

For example, the first separating membrane and the second separating membrane to divide the three-compartment electrolytic cell 10 may not necessarily be ion-exchange membranes. A filtration membrane or a porous membrane having a controlled permeability may be used as the separating membrane. The electrolytic apparatus 1 of the above-described embodiment can achieve a desirable hydraulic pressure condition accurately and stably in the intermediate chamber 18a, and therefore even in the case of using a permeable separating membrane, electrolyzed water as desired can be obtained by optimizing the condition of hydraulic pressure.

Further, an electrolyte solution may be other than a salt solution and appropriately selected depending on the intended use. Still further, the electrolyzed water to be produced is not limited to hypochlorous acid water or sodium hydroxide water and may be appropriately selected depending on the intended use.

Still further, the means to control the pressure (volume) of a flowing solution in the circulation pipe is not limited to the manual valve 200 and may be an orifice or a filter having controlled permeability. Further, the circulation pipe 32 may be configured to control the flow volume by using the diameter or the shape of the pipe itself instead of comprising a flow restriction member.

What is claimed is:

1. An electrolytic apparatus comprising:
an electrolytic cell comprising a first separating membrane configured to separate an intermediate chamber to which an electrolyte solution is supplied and an anode chamber, a second separating membrane configured to separate the intermediate chamber and a cathode chamber, an anode provided in the anode chamber to face the first separating membrane, and a cathode provided in the cathode chamber to face the second separating membrane;
a supply portion configured to supply the electrolyte solution to the intermediate chamber;
a drain pipe comprising an end opened to an outside and configured to discharge the electrolyte solution from the intermediate chamber; and
a valve provided in the drain pipe and configured to make the electrolyte solution in the intermediate chamber static,
wherein the supply portion comprises a pressure apply portion configured to apply hydrostatic pressure to the electrolyte solution in the intermediate chamber made static, a supply pipe connected to the intermediate chamber, a pump provided in the supply pipe to feed an electrolyte solution to the intermediate chamber, and a circulation pipe configured to circulate a part of the electrolyte solution fed from the pump.

2. The electrolytic apparatus of claim 1, wherein the pressure apply portion comprises a flow controller provided in the circulation pipe and configured to control a flow of the electrolyte solution in the circulation pipe, and the flow controller controls hydraulic pressure in the intermediate chamber by controlling the flow.

3. The electrolytic apparatus of claim 1, wherein the hydrostatic pressure is higher than hydraulic pressure of the anode chamber and of the cathode chamber.

4. The electrolytic apparatus of claim 1, wherein the circulation pipe comprises one end connected to the supply pipe on an outflow side of the pump and the other end connected to the supply pipe on an inflow side of the pump.

5. The electrolytic apparatus of claim 1, wherein the supply portion comprises a tank configured to store an electrolyte solution, and the supply pipe comprises is connected to the tank.

6. The electrolytic apparatus of claim 5, wherein the circulation pipe is connected to the tank so as to return a part of the electrolyte solution supplied from the pump back to the tank.

7. The electrolytic apparatus of claim 1, wherein the valve is an electromagnetic valve, and which further comprises a controller configured to apply voltage to the cathode and to the anode when the electromagnetic valve is closed.

8. The electrolytic apparatus of claim 1, wherein the valve is a safety valve configured to open when hydraulic pressure in the intermediate chamber is a predetermined value or more.

9. The electrolytic apparatus of claim 8, which further comprises an electromagnetic valve provided at the circulation pipe, and wherein the safety valve closes when the electromagnetic valve is open to make the electrolyte solution in the intermediate chamber static, and the safety valve opens as the hydraulic pressure of the intermediate chamber increases when the electromagnetic valve is closed to discharge the electrolyte solution in the intermediate chamber.

10. The electrolytic apparatus of claim 1, wherein the supply portion comprises a check valve provided in the supply pipe between the intermediate chamber and the pump and configured to restrain the electrolyte solution in the intermediate chamber from running toward the pump.

11. A method for producing an electrolyzed water by an electrolytic apparatus comprising: an electrolytic cell comprising a first separating membrane configured to separate an intermediate chamber to which an electrolyte solution is supplied and an anode chamber, a second separating membrane configured to separate the intermediate chamber and a cathode chamber, an anode provided in the anode chamber to face the first separating membrane, and a cathode provided in the cathode chamber to face the second separating membrane; a supply portion comprising a pressure apply portion and configured to supply the electrolyte solution to the intermediate chamber; a drain pipe comprising an end opened to an outside and configured to discharge the electrolyte solution from the intermediate chamber; and a valve provided in the drain pipe and configured to make the electrolyte solution in the intermediate chamber static, the method comprising:
supplying water to the anode chamber and to the cathode chamber;
supplying an electrolyte solution to the intermediate chamber through a supply pipe;
making the electrolyte solution in the intermediate chamber static;
applying hydrostatic pressure to the electrolyte solution in the intermediate chamber made static by the pressure apply portion;
circulating a part of the supplied electrolyte solution through a circulation pipe connected to the supply pipe; and
applying positive voltage and negative voltage respectively to the anode and to the cathode.

12. The method of claim 11, further comprising: controlling hydraulic pressure in the intermediate chamber by a flow controller provided in the circulation pipe.

13. The method of claim 11, further comprising:
opening a valve provided at the drain pipe at given times and discharging the electrolyte solution in the intermediate chamber from the drain pipe; and
supplying a new electrolyte solution to the intermediate chamber by the supply portion.

14. The method of claim 11, wherein the applying hydrostatic pressure to the electrolyte solution comprises applying hydrostatic pressure higher than hydraulic pressure of the anode chamber and the cathode chamber to the electrolyte solution in the intermediate chamber made static.
